(19) United States
(12) Patent Application Publication
(10) Pub. No.: US 2025/0118522 A1
(43) Pub. Date: Apr. 10, 2025

(54) COOLED ROTATING ANODE X-RAY SOURCE

(71) Applicant: CurveBeam, LLC, Hatfield, PA (US)

(72) Inventors: Frank Speranza, Warminster, PA (US); Sean Brogan, Willow Grove, PA (US)

(73) Assignee: CurveBeam, LLC, Hatfield, PA (US)

(21) Appl. No.: 18/903,063

(22) Filed: Oct. 1, 2024

Related U.S. Application Data
(60) Provisional application No. 63/543,335, filed on Oct. 10, 2023.

(51) Int. Cl. H01J 35/10; H01J 35/16

(52) U.S. Cl. CPC H01J 35/106; H01J 35/16; H01J 2235/127; H01J 2235/1275

(57) ABSTRACT

A rotating anode x-ray generator, comprising: a rotating anode x-ray source; an x-ray generator housing having an interior volume that houses the x-ray source and is configured to contain electrically insulating cooling oil for cooling the x-ray source immersed therein; a radiator exterior to the housing and configured to cool the cooling oil, and having an oil intake and an oil outlet in fluid communication with the interior volume; one or more oil pumps configured to pump the cooling oil from the interior volume of the housing into the radiator via the oil intake, such that the cooling oil passes through the radiator and returns back into the interior volume of the housing via from the oil outlet; and a fan configured to blow air over vanes of the radiator to cool the radiator and thereby increase an oil cooling capacity of the radiator.

### RELATED APPLICATION

This application is based on and claims the benefit of the filing and priority dates of U.S. provisional patent application Ser. No. 63/543,335 filed 10 Oct. 2023, the content of which as filed is incorporated herein by reference in its entirety.

### FIELD OF THE INVENTION

The present invention relates to an x-ray generator with a cooled rotating anode x-ray source, and in particular to such a generator adapted for use in x-ray radiography or computed tomography.

### BACKGROUND

One existing x-ray generator used in x-ray radiography or computed tomography includes a cathode and a rotating, tungsten anode within an evacuated envelope. The envelope is typically of glass and referred to as a tube (though it is not, despite its name, of strictly cylindrical form), and is located within an enclosure. X-rays are produced by passing a heating current through a filament of the cathode, prompting the heated filament to thermionically emit a cloud of electrons. A potential of, for example, 40 kV to 150 kV is applied between the cathode and the anode to accelerate the emitted electrons towards the anode within the envelope. In addition, the cathode is configured to focus the electrons so that they impinge on a target region of the anode, thereby generating x-rays.

Both the envelope and the enclosure have windows that transmit the x-rays, such as to an external collimator that controls the form of the resulting x-ray beam.

The bulk of the energy of the electrons impinging on the anode acts to heat the anode rather than to generate x-rays so. To avoid excessive heating of the anode, the anode—which is circular—is supported on a rotor located within the envelope and driven inductively to rotate by a motor located outside the envelope but within the enclosure. The rotation distributes the heat generated in the anode.

This configuration is illustrated highly schematically at 10 in FIG. 1. Evacuated envelope 12 contains cathode 14 (with cathode filament 16), anode 18 (with peripheral electron target area 20), and rotor 22 that supports and rotates anode 18. Envelope 12 is located within an enclosure 24, which is located within a housing 26 that comprises a main plate and a cover. The motor (not shown) that inductively drives rotor 22 is located within enclosure 24, external to envelope 12.

The volume within enclosure 24 surrounding envelope 12, and the volume within housing 26 surrounding enclosure 24, are in fluid communication and are filled with an electrical insulating oil 28. Heat from anode 18 is radiated or conducted to, and absorbed by, oil 28 within enclosure 24, and carried by conduction and convection to the oil surrounding enclosure 12. A cooling system 30 includes copper tube coils 32 that extend into housing 26, and circulates cooling water through coils 32 to remove heat from oil 28. The cooling water is then cooled by being circulated through an external radiator (not shown). However, this cooling system adds complexity to the system.

Alternatively, cooling of the oil can be effected by attaching a thick aluminum plate to the main plate of housing 26. The aluminum plate is in intimate thermal contact with the main plate and external to the housing 26, so the oil's heat is transferred by conduction first to the main plate and then to the aluminum plate. The aluminum plate then conducts the heat away to the surrounding air. However, this approach may not provide sufficient cooling capacity in some applications.

### SUMMARY

It is an object of the present invention to provide a high-capacity but simple cooling mechanism for a rotating anode x-ray source.

According to a first aspect of the present invention, therefore, there is provided a rotating anode x-ray generator, comprising:
a. a rotating anode x-ray source;
b. an x-ray generator housing having an interior volume that houses the x-ray source and is configured to contain electrically insulating cooling oil for cooling the x-ray source immersed therein;
c. a radiator exterior to the housing and configured to cool the cooling oil, and having an oil intake and an oil outlet in fluid communication with the interior volume;
d. one or more oil pumps configured to pump the cooling oil from the interior volume of the housing into the radiator via the oil intake, such that the cooling oil passes through the radiator and returns back into the interior volume of the housing via from the oil outlet; and
e. a fan configured to blow air over vanes of the radiator to cool the radiator and thereby increase an oil cooling capacity of the radiator.

Thus, cooling is provided without a secondary cooling circuit (cf. copper tube coils 32 of FIG. 1), with the one or more oil pumps configured to circulate the cooling oil from the interior volume of the housing into the radiator via the oil intake, through the radiator and back into the interior volume of the housing via from the oil outlet.

The x-ray generator may optionally include one or more thermostats configured to control the fan and/or the oil pumps so as to operate only above a temperature threshold (e.g. whether or not the x-ray tube is operating). The temperature threshold may correspond, for example, to the temperature of the cooling oil (e.g. within the housing or radiator), of the x-ray tube or of the radiator vanes.

In an embodiment, the x-ray generator comprises an x-ray source enclosure located or locatable within the housing, wherein the x-ray source is located within the x-ray source enclosure. In an example, the x-ray source enclosure has an oil inlet port for admitting the cooling oil to an interior of the x-ray source enclosure and an oil outlet port for the cooling oil to exit the interior of the x-ray source enclosure. The oil inlet port may be proximate one of a cathode end and a stator end of the x-ray source, and the oil outlet port proximate the other of the cathode end and the stator end of the x-ray source.

Thus, the x-ray source enclosure constrains flow of the cooling oil—at least to some degree—to be over or along the x-ray source. The x-ray source enclosure may be essentially fluid-tight to the cooling oil, apart from an oil inlet port and an oil outlet port. Alternatively, the x-ray source enclosure may not be fluid tight; one or both of its end walls may be partial or omitted entirely; in such embodiments, for example, cooled oil may be directed to one end of the enclosure and collected once heated by the x-ray source at the other-such as generally from x-ray tube to stator.

In another embodiment, the x-ray generator comprises a first oil pump arranged to pump the cooling oil from the interior volume of the housing to one of a cathode end and a stator end of the x-ray source, and a second oil pump configured to pump the cooling oil from the other of the cathode end and the stator end of the x-ray source to the intake of the radiator.

Thus, these two pumps (which may be regarded as first and second oil pumps of the one or more oil pumps) can be located at points of significant pumping impedance, such as the inlet port of the enclosure and the intake of the radiator. Also, lower power pumps can be employed such that the internal pressure of the housing and radiator is minimized compared with a single, higher powered pump.

In another embodiment, the one or more oil pumps deliver oil once cooled by the radiator at or towards a part of the x-ray source that is hottest during operation of the x-ray generator, such as the anode of the x-ray tube of the x-ray source.

Also, if a single oil pump is employed, it may be advantageous to deliver cooled oil from radiator at a location within housing that is remote from the intake of the oil intake of the radiator (or from an inlet conduit of the pump), such as by providing a conduit within the housing, coupled to the oil outlet of the radiator (or to an oil inlet of the housing that is coupled to the oil outlet of the radiator), and arranged to deliver cooling oil where desired, e.g. proximate the part of the x-ray tube that becomes hottest during operation.

In another embodiment, at least one of the one or more oil pumps (and in some examples both or all of the pumps) is located within the x-ray generator housing, such as—in use—immersed in cooling oil.

However, the one or more of the oil pumps may be located outside the housing, but in fluid communication with the interior volume of the housing (such as via respective oil conduits), thereby avoiding the need for those pumps to be sealed against unwanted oil ingress and avoiding the need for their electrical power to be fed into the housing.

According to this aspect, there is also provided a computed tomography system, comprising the above rotating anode x-ray generator.

According to a second aspect of the present invention, therefore, there is provided a method of cooling a rotating anode x-ray generator, the method comprising:
a. pumping electrically insulating cooling oil from an interior volume of an-ray generator housing that houses a rotating anode x-ray source of the x-ray generator into a radiator external to the housing, so that the cooling oil passes through the radiator;
b. cooling the radiator by blowing air over vanes of the radiator and thereby increasing an oil cooling capacity of the radiator; and
c. returning the cooling oil once cooled by the radiator to the interior volume of the housing.

In an embodiment, the method comprises locating the x-ray source within an x-ray source enclosure within the housing. In an example, the method comprises admitting the cooling oil to the x-ray source enclosure via an oil inlet port of the x-ray source enclosure, wherein the cooling oil exits from the x-ray source enclosure via an oil outlet port of the x-ray source enclosure. For example, the method may comprise admitting the cooling oil to the x-ray source enclosure proximate one of a cathode end and a stator end of the x-ray source, with the cooling oil exiting the x-ray source enclosure proximate the other of the cathode end and the stator end of the x-ray source.

In an embodiment, the method comprises pumping the cooling oil from the interior volume of the housing to one of a cathode end and a stator end of the x-ray source with a first oil pump, and pumping the cooling oil from the other of the cathode end and the stator end of the x-ray source to the intake of the radiator.

In an embodiment, the method comprises delivering the cooling oil once cooled by the radiator with the one or more oil pumps at or towards a part of the x-ray source that is hottest during operation of the x-ray generator.

In an embodiment, the method comprises locating at least one of the one or more oil pumps (and in some examples both or all of the pumps) within the x-ray generator housing, such as—in use—immersed in cooling oil.

It should be noted that any of the various individual features of each of the above aspects of the invention, and any of the various individual features of the embodiments described herein including in the claims, can be combined as suitable and desired.

### BRIEF DESCRIPTION OF THE DRAWING

In order that the invention may be more clearly ascertained, embodiments will now be described by way of example with reference to the following drawing, in which:

FIG. 1 is a schematic view of a cooled, rotating anode x-ray generator of the background art;

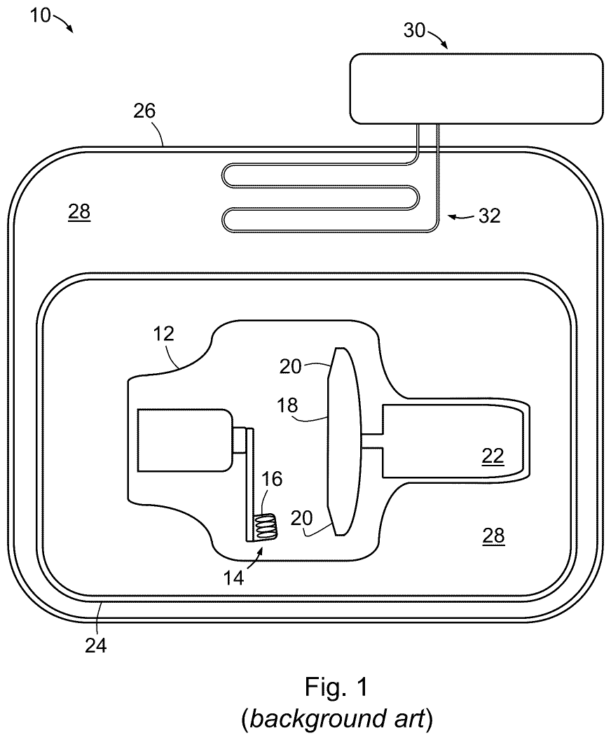

FIG. 2 is a schematic view of a cooled rotating anode x-ray generator according to an embodiment of the present invention;

FIG. 3 is a schematic cross-sectional view of the rotating anode x-ray generator of FIG. 2 according to an embodiment of the present invention; and

FIG. 4 is a flow diagram of a method of cooling a rotating anode x-ray generator according to an embodiment of the present invention.

### DETAILED DESCRIPTION

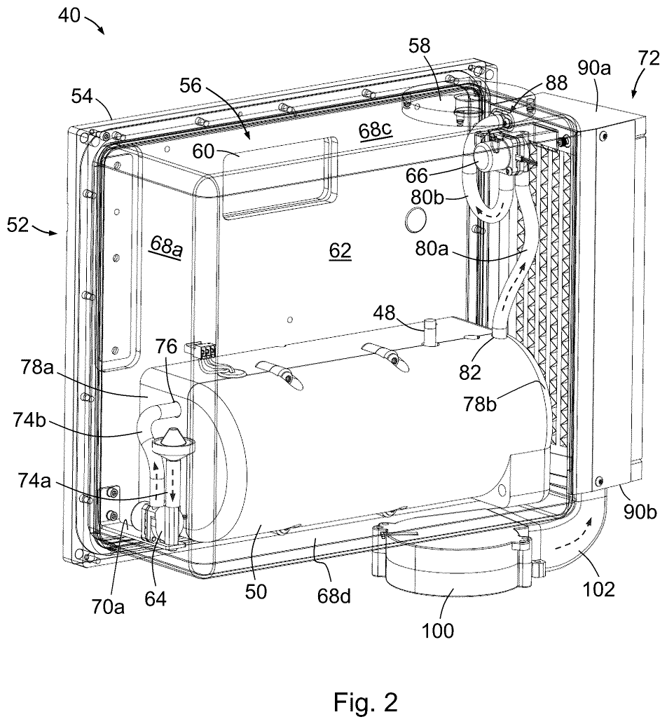

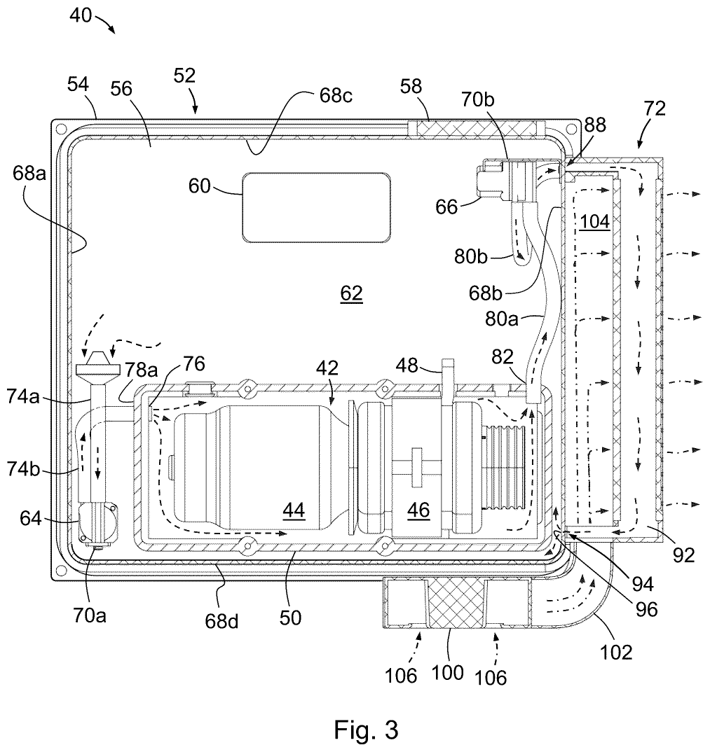

FIG. 2 is a schematic view, partially in ghost, of a cooled, rotating anode x-ray generator 40 according to an embodiment of the present invention. FIG. 3 is schematic cross-sectional view of cooled rotating anode x-ray generator 40. Each of these figures omits or modifies certain features for clarity.

Referring to FIGS. 2 and 3, x-ray generator 40 includes an x-ray source 42, which includes an x-ray tube 44, a stator 46 and a stator cable 48 (of which only a lower portion is shown for simplicity). X-ray source 42 is located within an x-ray generator enclosure 50, which can be opened to install or access x-ray source 42 and securely closed. X-ray tube 44, in this example, is an X22P® x-ray tube provided by IAE S.p.A. of Milan, Italy; x-ray tube 44 has anode of RT-TZM, a molybdenum-base alloy containing titanium and zirconium, an anode diameter of 64 mm and an anode rotation speed of 3000 rpm. X-ray tube 44 has a nominal tube voltage of 130 kV and a nominal anode input power of 3.8 KW at 27.1 mA or 10 KW at 71.4 mA. The anode has a heat storage capacity of 105 kJ and a continuous power dissipation of 300 W.

Enclosure 50 is housed in an x-ray generator housing 52 that includes a main plate 54 and a removable cover 56. Cover 56 includes an adaptor 58 for filling the housing with oil. Main plate 54 includes a cutout 60 for electrical feedthroughs (not shown).

Housing 52 is configured to be filled, via adaptor 58, with an electrically insulating oil 62 (such as transformer oil) to act as a cooling oil, and such that—in use—enclosure 50 is immersed in the oil 62. In this example, the oil is Diala S2 ZX-A™, provided by Shell USA, Inc.

X-ray generator 40 also includes a first oil pump 64 and a second oil pump 66, both within housing 52 external to enclosure 50 and electrically powered via electrical feeds (not shown). First oil pump 64 is mounted proximate a first end wall 68a (the left wall, in the views of FIGS. 2 and 3) of housing cover 56, on a first bracket 70a that is supported by main plate 54 towards a lower periphery of main plate 54. Second oil pump 66 is mounted proximate a second end wall 68b (the right wall, in the views of FIGS. 2 and 3, opposite first end wall 68a) of housing cover 56, on a second bracket 70b that is supported by second end wall 68b towards an upper periphery of second end wall 68b. Adaptor 58, it may be noted, is located on third end wall 68c (the top wall, in the views of FIGS. 2 and 3) of housing cover 56.

First and second oil pumps 64, 66 each has a pumping capacity of approximately 1.6 L/min (˜0.42 U.S. gal/min).

X-ray generator 40 also includes a radiator 72, for cooling the oil 62, mounted to the exterior of second end wall 68b of housing cover 56.

First oil pump 64 has an inlet conduit 74a arranged to draw oil 62 from the main body of oil within housing 52, and an outlet conduit 74b coupled to an inlet port 76 of enclosure 50 in or proximate to a first end wall 78a of enclosure 50. First oil pump 64 is thus configured to pump oil 62 into enclosure 50. (The length of inlet conduit 74a is exaggerated in FIG. 3 so as not to overly obscure outlet conduit 74b.) Second oil pump 66 has an inlet conduit 80a coupled to an outlet port 82 of enclosure 50 in or proximate to a second end wall 78b (opposite first end wall 78a) of enclosure 50. Second oil pump 66 is configured to draw oil from the interior of enclosure 50. In use, the oil exiting the interior of enclosure 50 may be at a temperature of up to 55 to 60° C. (˜130 to 140° F.).

Inlet port 76 and outlet port 82 of enclosure 50 are located remotely from one another so that oil flow within enclosure 50 traverses essentially the entire length of enclosure 50 and hence the length of the x-ray tube 42, so that all portions of the x-ray tube 42 are effectively cooled.

Second oil pump 66 has an outlet conduit 80b coupled to an intake 88 of radiator 72. Radiator intake 88 is located at an upper end 90a of radiator 68 such that oil flow within radiator 72 is downwards through finned radiator vanes 92 (of which only one is visible in the cross-sectional view of FIG. 3), with the oil exiting radiator 72 through an outlet 94 towards the lower end 90b of radiator 72. Radiator outlet 94 is coupled to an oil inlet 96 in housing cover 56, proximate second end wall 78b of enclosure 50, so oil exiting radiator 72 is discharged into the interior of housing 52 and thereby returns to the main body of oil 62 within housing 52.

X-ray generator 40 further includes an electrically powered centrifugal air blower or fan 100 for providing cooling air to radiator 72 and thereby increasing the cooling capacity of radiator 72. Fan 100 is mounted to the exterior of the fourth end wall 68d (the bottom end wall, ion the views of FIGS. 2 and 3) of housing cover 56, and—via an air conduit 102—feeds air 106 from the surroundings into a space 104 between second end wall 68b of housing cover 56 and vanes 92 of radiator 72. The air then flows past vanes 92 of radiator 72, thereby cooling the oil in those vanes 92, before being exhausted from radiator 72 (rightwards, in the view of FIG. 3).

Note that, in both FIGS. 2 and 3, oil flow is indicated by dashed curves, while air flow is indicated by dot-dash curves.

It is estimated that radiator 72, with the aid of fan 100, can cool the oil by approximately 7° C. (˜12° F.).

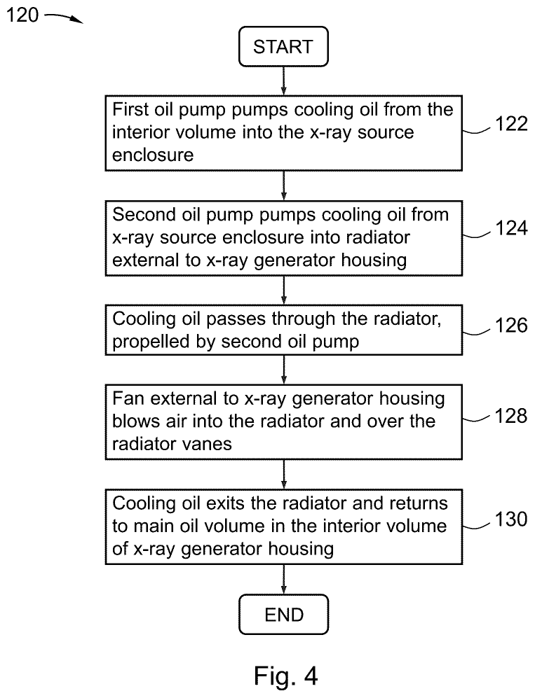

FIG. 4 is a flow diagram 120 of a method of cooling a rotating anode x-ray generator according to an embodiment of the present invention. Referring to FIG. 4, at step 122 first oil pump 64 pumps cooling oil 62 from the interior volume of housing 52 into x-ray source enclosure 50.

At step 124, second oil pump 66 pumps cooling oil from x-ray source enclosure 50 into radiator 72 external to x-ray generator housing 52.

At step 126, oil passes though (in this example, descends) radiator 72 within radiator vanes 92, propelled principally by the action of second oil pump 66. Simultaneously, at step 128, fan 100—which is external to x-ray generator housing 52—blows air into radiator 72; the air is directed over radiator vanes 92, to cool the radiator 72 and hence the oil in the radiator.

At step 130, cooling oil exits radiator 72 and returns to the main oil volume in the interior volume of housing 52.

Steps 122 to 130 operate continuously at least while x-ray generator 40 is in operation. In this example, x-ray tube 44 has an input of up to approximately 10 KW, but a heat dissipation rate of approximately 300 W (noting that only a small portion of the input power is converted into and emitted as x-rays). As a result, x-ray tube 44 dissipates heat for some time after being switched off and ceasing to generate x-rays. Consequently, oil pumps 64, 66 and fan 100 are generally operated for a period of time after the x-ray or CT scan is complete, typically until oil 62 and/or x-ray tube 44 are at an acceptably low temperature.

Various alternatives and modifications are envisaged. For example, in some applications, it is envisaged that radiator 72 may provide sufficient cooling without the operation of fan 100, such as if a lower power x-ray tube is employed (or x-ray tube 44 is operated at a lower power). For example, fan 100 may be controlled by a thermostat, such as a thermostat configured to respond to the temperature of the cooling oil or of the radiator vanes by switching on fan 100 when the temperature exceeds a first threshold and switching off fan 100 when the temperature is below a second threshold. Likewise, in some applications, oil pumps 64, 66 may be controlled by a thermostat configured to respond to the temperature of the cooling oil or of the radiator vanes by oil pumps 64, 66 on when the temperature exceeds a first threshold and switching oil pumps 64, 66 off when the temperature is below a second threshold. For example, a single thermostat may be employed to control both fan 100 and oil pumps 64, 66.

Enclosure 50 is essentially fluid-tight to the cooling oil, apart from its inlet port 76 and outlet port 82. However, in some alternatives enclosure 50 may not be fluid tight; one or both of end walls 78a and 78b may be partial or omitted entirely. Enclosure 50 nonetheless encourages oil flow therein to be along x-ray source 42 and in particular x-ray tube 44, in the general direction—in the configuration of FIGS. 2 and 3—from x-ray tube 44 to stator 46.

In another alternative, however, enclosure 50 is omitted, such that first and second oil pumps 64, 66 circulate oil 62 within housing 52 in general. In such an arrangement, it may be advantageous to locate the outlet end of outlet conduit 74b of first oil pump 64 close to the hottest portion of x-ray tube 44, such as below and aligned with the anode of x-ray tube 44.

In certain alternatives, a single oil pump may be employed, such as by omitting first oil pump 64 and relying on second oil pump 66 to draw oil into and along enclosure 50. If enclosure 50 is omitted, it may be advantageous to deliver cooled oil from radiator 72 at a location within housing 52 that is remote from the intake of the inlet conduit 80a of second pump 66. This may be implemented, for example, by providing a further conduit within housing 52, coupled to inlet 96, and arranged to deliver oil where desired, e.g. proximate the part of x-ray tube 44 that becomes hottest during operation (such as the anode). Alternatively, this may be implemented by locating radiator outlet 94 on a lower or side surface of radiator 72, locating housing cover oil inlet 96 remote from radiator 72 (e.g. proximate x-ray tube 44), and providing a further conduit outside housing 52 coupling radiator outlet 94 to oil inlet 96.

Additionally, one or both of first and second oil pumps 64, 66 may be located outside housing 52. For example, one or both may be mounted externally to main plate 54, such as within an oil pump housing. Respective oil conduits 74a, 74b and 80a, 80b may penetrate main plate 54 through one or more feedthroughs in main plate 54 so that first/or second oil pumps 64, 66 are in fluid communication with the interior, oil-filled volume of housing 52. In another example, second oil pump 66 (whether as sole oil pump or otherwise) may be mounted externally to housing 52, such as supported on radiator 72, with its intake coupled to inlet conduit 80a or with an inlet coupled to an oil outlet port in housing 52 that is coupled to inlet conduit 80a. These examples, which may be combined with the other variations, eliminate the need for the first/or second oil pumps 64, 66 to be sealed against unwanted oil ingress and for their electrical power to be fed into housing 52.

It will be understood to persons skilled in the art of the invention that many modifications may be made without departing from the scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A rotating anode x-ray generator, comprising:
a rotating anode x-ray source;
an x-ray generator housing having an interior volume that houses the x-ray source and is configured to contain electrically insulating cooling oil for cooling the x-ray source immersed therein;
a radiator exterior to the housing and configured to cool the cooling oil, and having an oil intake and an oil outlet in fluid communication with the interior volume;
one or more oil pumps configured to pump the cooling oil from the interior volume of the housing into the radiator via the oil intake, such that the cooling oil passes through the radiator and returns back into the interior volume of the housing via from the oil outlet; and
a fan configured to blow air over vanes of the radiator to cool the radiator and thereby increase an oil cooling capacity of the radiator.

2. The x-ray generator of claim 1, comprising an x-ray source enclosure located or locatable within the housing, wherein the x-ray source is located within the x-ray source enclosure.

3. The x-ray generator of claim 2, wherein the x-ray source enclosure has an oil inlet port for admitting the cooling oil to an interior of the x-ray source enclosure and an oil outlet port for the cooling oil to exit the interior of the x-ray source enclosure.

4. The x-ray generator of claim 3, wherein the oil inlet port is proximate one of a cathode end and a stator end of the x-ray source, and the oil outlet port is proximate the other of the cathode end and the stator end of the x-ray source.

5. The x-ray generator of claim 1, comprising a first oil pump arranged to pump the cooling oil from the interior volume of the housing to one of a cathode end and a stator end of the x-ray source, and a second oil pump configured to pump the cooling oil from the other of the cathode end and the stator end of the x-ray source to the oil intake of the radiator.

6. The x-ray generator of claim 1, wherein the one or more oil pumps deliver oil once cooled by the radiator at or towards a part of the x-ray source that is hottest during operation of the x-ray generator.

7. The x-ray generator of claim 1, wherein at least one of the one or more oil pumps is located within the x-ray generator housing.

8. The x-ray generator of claim 1, comprising a first oil pump arranged to pump the cooling oil from the interior volume of the housing to one of a cathode end and a stator end of the x-ray source, and a second oil pump configured to pump the cooling oil from the other of the cathode end and the stator end of the x-ray source to the intake of the radiator;
wherein the one or more oil pumps deliver oil once cooled by the radiator at or towards a part of the x-ray source that is hottest during operation of the x-ray generator.

9. The x-ray generator of claim 8, wherein at least one of the one or more oil pumps is located within the x-ray generator housing.

10. A computed tomography system, comprising the rotating anode x-ray generator of claim 1.

11. A method of cooling a rotating anode x-ray generator, the method comprising:
pumping electrically insulating cooling oil from an interior volume of an-ray generator housing that houses a rotating anode x-ray source of the x-ray generator into a radiator external to the housing, so that the cooling oil passes through the radiator;
cooling the radiator by blowing air over vanes of the radiator and thereby increasing an oil cooling capacity of the radiator; and
returning the cooling oil once cooled by the radiator to the interior volume of the housing.

12. The method of claim 11, comprising locating the x-ray source within an x-ray source enclosure within the housing.

13. The method of claim 12, comprising admitting the cooling oil to the x-ray source enclosure via an oil inlet port of the x-ray source enclosure, wherein the cooling oil exits from the x-ray source enclosure via an oil outlet port of the x-ray source enclosure.

14. The method of claim 13, comprising admitting the cooling oil to the x-ray source enclosure proximate one of a cathode end and a stator end of the x-ray source, with the cooling oil exiting the x-ray source enclosure proximate the other of the cathode end and the stator end of the x-ray source.

15. The method of claim 11, comprising pumping the cooling oil from the interior volume of the housing to one of a cathode end and a stator end of the x-ray source with a first oil pump, and pumping the cooling oil from the other of the cathode end and the stator end of the x-ray source to an oil intake of the radiator.

16. The method of claim 11, comprising delivering the cooling oil once cooled by the radiator with the one or more pumps at or towards a part of the x-ray source that is hottest during operation of the x-ray generator.

17. The method of claim 11, comprising locating at least one of the one or more oil pumps within the x-ray generator housing.

18. The method of claim 11, comprising pumping the cooling oil from the interior volume of the housing to one of a cathode end and a stator end of the x-ray source with a first oil pump, and pumping the cooling oil from the other of the cathode end and the stator end of the x-ray source to an oil intake of the radiator; and
delivering the cooling oil once cooled by the radiator with the one or more oil pumps at or towards a part of the x-ray source that is hottest during operation of the x-ray generator.

19. The method of claim 17, comprising locating at least one of the one or more oil pumps within the x-ray generator housing.
